(19) United States
(12) Patent Application Publication
(10) Pub. No.: US 2025/0220111 A1
(43) Pub. Date: Jul. 3, 2025

(54) CONTROL METHOD, APPARATUS AND STORAGE MEDIUM

(71) Applicant: Lenovo (Beijing) Limited, Beijing (CN)

(72) Inventors: Shi CHEN, Beijing (CN); Xiangyang LI, Beijing (CN); Wei ZHANG, Beijing (CN)

(21) Appl. No.: 19/001,213

(22) Filed: Dec. 24, 2024

(30) Foreign Application Priority Data
Dec. 27, 2023 (CN) 202311825362.X

(51) Int. Cl. H04M 1/72463; H04M 1/72412

(52) U.S. Cl. CPC H04M 1/724634; H04M 1/72412

(57) ABSTRACT

This application provides a method for controlling devices, a device control apparatus, and a computer readable storage medium. The method for controlling devices includes determining that a state of a connection between a first device and a second device has changed; determining that the first device is in a target state, wherein in the target state, the first device is connected to the second device through a first connection, and based on the first connection, the first device maintains an unlocked screen state; and performing a first operation, the first operation being used to make the first device exit the target state.

### CROSS-REFERENCE TO RELATED APPLICATION

This application claims priority to Chinese Patent Application No. 202311825362.X, filed on Dec. 27, 2023, and the entire content of which is incorporated herein by reference.

### TECHNICAL FIELD

The present disclosure relates to the field of computer technology, specifically to a method for controlling devices, an equipment, and a storage medium.

### BACKGROUND

When using electronic devices, one electronic device can be used to unlock another device. However, in such scenarios, there may be issues with unintended unlocking, which reduces the security of using the electronic devices.

### SUMMARY

One aspect of the present disclosure provides a method for controlling devices. The method is applied to the first electronic device. The method includes: determining that a state of a connection between a first device and a second device has changed; determining that the first device is in a target state, wherein in the target state, the first device is connected to the second device through a first connection, and based on the first connection, the first device maintains an unlocked screen state; and performing a first operation, wherein the first operation is used to make the first device exit the target state.

Another aspect of the present disclosure provides an apparatus for controlling devices. The apparatus includes: a first determination unit, configured to determine that a state of a connection between a first device and a second device has changed; a second determination unit, configured to determine that the first device is in a target state, wherein in the target state, the first device is connected to the second device through a first connection, and based on the first connection, the first device maintains an unlocked screen state; and a first execution unit configured to performing a first operation, wherein the first operation is used to make the first device exit the target state.

Another aspect of the present disclosure provides a computer readable storage medium. The computer readable storage medium stores a computer program configured to implement the method for controlling devices described above. The computer program is executed by the processor to achieve any of the method for controlling devices mentioned above.

### BRIEF DESCRIPTION OF THE DRAWINGS

To more clearly illustrate the technical solutions in the embodiments of the present disclosure, drawings required for the description of the embodiments are briefly described below. Obviously, the drawings described below are merely some embodiments of the present disclosure. For those skilled in the art, other drawings can be obtained based on these drawings without creative efforts.

FIG. 1 is a flowchart of a method for controlling devices provided in an embodiment of the present disclosure;

FIG. 2 is a diagram of an embodiment provided in an embodiment of the present disclosure;

FIG. 3 is a schematic diagram of a device control apparatus provided in an embodiment of the present disclosure;

### DETAILED DESCRIPTION OF THE EMBODIMENTS

To enable those skilled in the art to better understand the technical solutions of the embodiments of the present disclosure, the technical solutions in the embodiments of the present disclosure will be clearly and completely described below in conjunction with the accompanying drawings. Obviously, the described embodiments are merely part of the embodiments of the present disclosure, not all of the embodiments. Based on the embodiments of the present disclosure, all other embodiments obtained by those skilled in the art without creative work are within the scope of the present disclosure.

The terms “first” and “second” in the description, claims, and accompanying drawings of the present disclosure are used to distinguish different objects, not to indicate a specific sequence. Furthermore, the terms “comprise” and “include,” as well as any of their variations, are intended to cover inclusive rather than exclusive inclusion. For example, a process, method, system, product, or device comprising a series of steps or elements is not limited to those explicitly listed but may also include steps or elements not listed.

The present disclosure provides a method for controlling devices. The method can be applied to a system comprising multiple devices. These devices can communicate with each other through specific connections. For instance, two devices in the system can be connected via wireless connection, wired connection, or mechanical structures. The connection enables the devices to share functional modules, or combine the devices into a specific form to switch between functions or apply corresponding functions. By implementing the method for controlling devices of the present disclosure, the security of devices in such embodiments can be improved. The entity executing the method in this embodiment can be a first device, and a second device, or a combination of the first device and the second device.

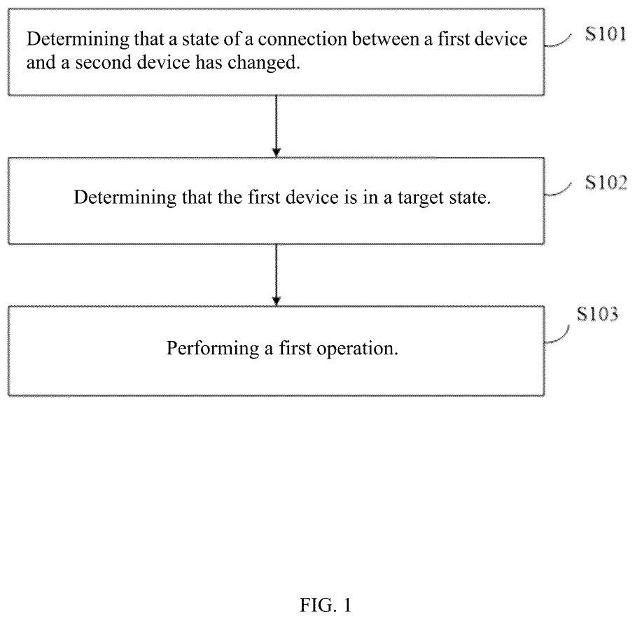

In order to facilitate the explanation of this embodiment of the present disclosure, a system of devices including a first device and a second device can be taken as an example. FIG. 1 is a flow diagram of the method for controlling devices provided in an embodiment of the present disclosure. The method includes the following steps:

At S101, determining that the state of a connection between the first device and the second device has changed.

The first device and the second device can be devices with the same functional modules, or devices with different functional modules. Furthermore, their physical forms may be identical or different, and the operating systems used for data processing may also be identical or different. For example, the first device could be an electronic device with a display output module running the Android operating system, while the second device could be a display device with an input module running the Windows operating system. Alternatively, the first device could be a smartphone, laptop, or tablet, while the second device could be a smart wristband, smartwatch, wireless earphones, or wireless mouse. The first device and the second device can be connected via wired, wireless, or mechanical components. For example, the first device and the second device can establish wireless or wired connections to enable data transmission and sharing. The first device and the second device can also be connected through mechanical components to form as one device with integrated functionality. For instance, the first device and the second device can be connected using detachable components, which creates a system that allows shared use of the functional modules of both devices.

The change in the state of a connection between the first device and the second device may refer to a change in their operational state based on the current connection mode. For example, when the first device and the second device are in a connected state, the mode may switch from the first device sending data to the second device to the second device sending data to the first device. Correspondingly, the change in the state of a connection between the first device and the second device may also refer to a physical connection change, such as transitioning from connected to disconnected or vice versa. For instance, when the first device is connected to the second device via a detachable connector, a change in state of a connection would mean the first device transitioning from being inserted into the second device to being removed from it. The change in the state of a connection may also involve wireless connections between the first device and the second device. This includes transitions such as a wireless connection like NFC or Bluetooth changing from connected to disconnected, or from disconnected to connected. When the state of a connection between the first device and the second device changes, it affects the application of the functional modules of the devices, and also degrades the security of the corresponding devices. Therefore, in this embodiment, operations are executed based on information about the change in the state of a connection between the first and second devices, to ensure the security of the devices.

At S102, determining that the first device is in a target state.

Determining that the first device is in the target state, is performed in response to a change in the state of a connection between the first device and the second device. In the target state, the first device and the second device are connected through a first connection, and based on this first connection, the first device remains in an unlocked screen state. In other words, when the first device is in the target state, automatic unlocking can be performed. For example, the first connection could be a Bluetooth connection, and when the first device and the second device are in close proximity, which means within the Bluetooth connection range, and the second device is listed as a trusted device for the first device, the second device can cause the screen of the first device to be at a unlocked state. Therefore, this first connection serves as a trigger for unlocking or locking the screen of the first device. The change in the state of a connection between the first device and the second device specifically includes a change in the state of a connection of a second connection, wherein the second connection is different to the first connection. When the state of a connection of the second connection changes, it does not affect the state of a connection of the first connection. Consequently, if the state of a connection of the first connection does not follow the changes in the second connection and remains uninterrupted, the first device may continue to stay in the unlocked state. This situation can result in security issues or cause discrepancies between the screen states of the first device and the second device, which also affects the user experience.

At S103, performing a first operation.

The first operation is used to move the first device out of the target state. Exiting the target state may refer to terminating the automatic screen unlocked state of the first device. In this embodiment, when it is detected that the state of a connection between the first device and the second device has changed and the first device is in the target state, where its screen remains unlocked based on the first connection with the second device, the first operation can make the first device exit the automatic screen unlocked state. For example, if the first connection is a Bluetooth connection, the first operation could involve removing the information of the second device from the Bluetooth trusted device list of the first device. In this case, even if the second device remains within the Bluetooth unlocking range of the first device, it will no longer trigger automatic unlocking on the first device which ensures its security. Alternatively, the first operation could involve disconnecting the first connection.

In one embodiment of the present disclosure, the change in the state of a connection between the first device and the second device includes:

the first device and the second device switching from a first state of a connection to a second state of a connection.

In this case, in the first state of a connection, the first device receives and displays the display data of the second device, while the second device remains in a locked screen state. In the second state of a connection, the first device receives keyboard data from the second device and displays its own display data. For example, the first device, as a hardware system platform, has its own operating system, such as the Android operating system. When used independently, the first device resembles a tablet and may include functional components such as a display, touchscreen, camera, and audio module. The second device may also have its own operating system, such as the Windows operating system, and could be equipped with functional components like a keyboard, mouse, or touch module. When the first device and the second device are connected, there can be two distinct state of a connections (including the first state of a connection and the second state of a connection), and these states are primarily determined based on the operational modes of the first and second devices after connection.

In the first state of a connection, the first device receives and displays the display data of the second device. In this state, the first device can share its functional components, such as its display, touchscreen, camera, and audio module, with the Windows operating system of the second device. This enables the display of the first device to show data determined based on the operating system of the second device, which allows the first device to receive and display the display data from the second device. In the second state of a connection, the first device receives keyboard input data from the second device and displays its own display data. Specifically, in the second state of a connection, the second device shares its input functional components (such as a keyboard, mouse, or touchpad) with the first device. This allows the first device to utilize the input functional components of the second device within the Android operating system of the first device. At this point, the display components (e.g., the screen) of the first device can display data that the first device processes or receives on its own.

In this embodiment of the present disclosure, when the first device and the second device switch from the aforementioned first state of a connection to the second state of a connection, the first device can exit the automatic unlock state by removing the second device from its trusted device list. For example, if the first connection is a Bluetooth connection, in the first state of a connection, the second device can unlock the screen of the first device by establishing a Bluetooth connection. When switching from the first state of a connection to the second state of a connection, the information of the second device is removed from the Bluetooth trusted device list of the first device. As a result, even if the second device remains within the Bluetooth connection range of the first device, it can no longer unlock the screen of the first device. This ensures the security of the first device. This also ensures that even when the state of a connection between the first and second devices changes, the screen state of the first device remains consistent before and after the state of a connection change. This prevents unintended operations such as unlocking or locking the screen of the first device due to changes in the state of a connection between the two devices, which further improves device security.

Furthermore, while enhancing device security, the screen state of the first device can also match the state of the operating system of the second device. This aligns better with the actual embodiment of the devices. In one embodiment of the present disclosure, the method for controlling devices further includes:

determining that the first device and the second device switched from a third state of a connection to the second state of a connection;

determining that the first device is not in the target state;

executing the second operation.

In this case, in the third state of a connection, the first device receives and displays the display data of the second device, while the second device is in an unlocked screen state. For example, the first device is a device based on the Android operating system, and the second device is based on the Windows operating system. In the third state of a connection, the second device is in an unlocked screen state, and the first device receives and displays the display data from the second device. In the second state of a connection, the second device shares its input functional components (such as a keyboard, mouse, or touchpad) with the first device, which allows the first device to utilize the input components of the second device through its Android operating system. In this case, the display components (e.g., the screen) of the first device can display data processed by the first device itself or data it has received. In this embodiment, before the changing of state of a connection, the Windows operating system of the second device corresponds to an unlocked screen state, and the unlocked state of the Android operating system of the first device follows the Windows operating system of the second device. The second operation performed may involve adding the relevant information of the second device to the trusted device list of the first device, which allows the first device to enter an automatic unlock state. This enables the screen of the first device to be unlocked through the first connection between the first and second devices.

In another embodiment of the present disclosure, the change in the state of a connection between the first device and the second device includes:

the first device and the second device switching from a fourth state of a connection to a fifth state of a connection.

In the fourth state of a connection, the first device and the second device are connected through both the first connection and the second connection; in the fifth state of a connection, the first connection between the first device and the second device remains connected, while the second connection is disconnected.

In some embodiments of the present disclosure, the first connection established between the first device and the second device can be used to trigger the screen of the first device to switch between the unlocked state and the locked state. For example, the first connection may be a type of short-range device connection, such as a Bluetooth connection, while the second connection between the first device and the second device can be a type of connection that alters the state of a connection between the two devices. For instance, the second connection could be a wired connection. In the fourth state of a connection, the first device and the second device are connected through a specific data cable, while in the fifth state of a connection, the data cable is unplugged, which makes the first device and the second device to disconnect. Alternatively, the second connection could be a direct physical connection (e.g., a fixed wire connection or a direction made by direct contact of two components). In the fourth state of a connection, the first device is inserted into the second device via a detachable connector, which makes a connection between the two devices, while in the fifth state of a connection, the first device can be removed from the second device by detaching the connector, which disconnects the two devices.

When the first device and the second device are in the fourth state of a connection, such as when the first device is inserted into the second device via a detachable connector, the first device enters an automatic unlock state. In this state, the screen of the first device can be unlocked through the second device when the second device is connected to the first device through the first connection. When the first device and the second device are in the fifth state of a connection, such as when the detachable connector of the first device is removed from the second device, the second device is removed from the trusted device list of the first connection of the first device. This makes the first device exit the automatic unlock state, which means that the screen of the first device cannot be unlocked through the first connection with the second device, so that the screen of the first device remains in a locked state. In this case, when the first device and the second device are not connected via the aforementioned detachable connector, even if the second device is in close proximity to the first device and satisfies the conditions for Bluetooth connection-based unlocking, the screen of the first device will not be unlocked. This ensures the security of the first device when it is used independently.

Specifically, when the first connection is a wireless connection, such as a Bluetooth connection, the connection between the first device and the second device can be determined by detecting the channel state information of the Bluetooth communication channel between them. Correspondingly, the second connection can be a direct physical connection. If this direct physical connection is established through a detachable connector of the first device, the second state of a connection between the first and second devices can be determined by detecting whether the detachable connector is inserted into the first device. More specifically, the state of the connection interface between the second device and the detachable connector can be detected to make this determination. For instance, if the direct physical connection is established via a wired connection between the first and second devices, the state of the second connection can be determined by checking the continuity of the wired communication channel. This can involve detecting the interface state of the wired communication ports on the first device and/or the second device, to determine the connectivity of the wired communication channel. Alternatively, the connectivity of the wired communication channel can be determined by detecting the state of the switch that controls the wired communication channel on the first and/or second device.

In another embodiment of the present disclosure, the first connection can be a wireless connection, and the second connection can also be a wireless connection. However, the first connection and the second connection are different. The maximum connection distance of the second connection shall be shorter than the maximum connection distance of the first connection.

For example, the first connection can be a Bluetooth connection, while the second connection can be a Near Field Communication (NFC) connection. Using NFC technology, the first device and the second device can exchange data when they are in close proximity. In this case, if the first device is a smartwatch and the second device is a smartphone, the smartphone shall only be unlocked after the smartwatch establishes a Bluetooth connection with the smartphone and is close enough to the smartphone in order to trigger an NFC connection.

In this embodiment of the present disclosure, when the first device and the second device establish a first connection, the first device remains in the unlocked screen state, based on this connection. This means that when the first connection is established between the first and second devices, the first device can be in the automatic unlock state. If a change in the state of a connection between the first device and the second device is detected, then the first operation can be executed to move the first device out of the target state, which also makes the first device to exit the automatic unlock state.

Specifically, in one embodiment of the present disclosure, executing the first operation includes:

Removing the device information of the second device from the trusted device list of the first device, wherein the first device remains in the unlocked screen state, if it establishes a specific connection with a device recorded in the trusted device list. For example, when the first device is currently in the locked screen state and the second device is included in the trusted device list of the first device, if the second device satisfies a specific connection condition with the first device, such as meeting the Bluetooth unlock state of a connection with the first device, and the second device is within the Bluetooth connection range of the first device, a Bluetooth connection can be established between the second device and the first device. This allows the screen of the first device to be unlocked via the second device. However, if the device information of the second device is removed from the trusted device list of the first device, even if the second device maintains the connection described above with the first device, it will no longer be able to unlock the screen of the first device, which ensures the security of the first device.

In another embodiment of the present disclosure, executing the first operation may also include:

disconnecting the first connection.

In some embodiments of the present disclosure, to make the first device exit the target state, such as exiting the automatic unlock mode, the first connection can be directly disconnected. This is because, in the present disclosure, when the first device is in the target state, such as the automatic unlock mode, the first device is connected to the second device through the first connection. Based on the first connection, the first device remains in the screen unlocked state, and the first connection enables to trigger the screen unlocking operation of the first device. Therefore, disconnecting the first connection can directly disable the unlocking through the first connection, which makes the first device exit the automatic unlock mode. This ensures that even when the state of a connection between the first device and the second device changes, the security requirements of the device can still be satisfied.

The following content provides a specific embodiment to illustrate the method for controlling devices provided in the present disclosure.

In this embodiment, the operating system of the first device is Android, and when used independently, its form is similar to a tablet computer. It may include functional components such as a display, a touch screen, a camera, and an audio module. For clarity of explanation, here the first device is represented as a Slate platform. The operating system of the second device is Windows, and when used independently, its form is similar to a computer base. It may include functional components such as a keyboard, mouse, and touch input pad. For clarity of explanation, here the second device is represented as a Base platform. When the Slate and the Base are connected, they can have two operating modes. Based on these two operating modes, there are two state of a connections. In one operating mode (referred to as Green Mode), the Base shares functional components such as a keyboard, mouse, and touchpad with the Android operating system. In another operating mode (referred to as Power Mode), the Slate shares functional components such as the display, touch screen, camera, and audio module with Windows.

In the embodiment where the Slate and the Base are used together, the Base needs to pair with the Slate to enable the automatic unlock function for the Slate. Typically, this can be achieved by a smart unlocking solution based on Bluetooth, which utilizes operating mode of the trusted device, to enable automatic unlocking. However, it is problematic, if a direct unlocking solution based on Bluetooth is applied. For instance, when the Slate is detached from the Base, the Slate device remains in the automatic unlock state as long as it stays within a certain range of the Base. In this case, it com promises the security of using the Slate independently. The method for controlling devices provided in the present disclosure can address this issue.

In one embodiment, while the Slate and the Base are connected, when switching from the Power mode to the Green mode, the locked screen state of the Android system of the Slate, must align with the locked screen state of the Windows system of the Base. For instance, if the Windows system is locked in Power Mode and the Android system remains in the automatic unlock state, then the device information of the Base shall be removed from the trusted device list of the Slate during the switch, to make the Slate exit the automatic unlock state. Conversely, if the Windows system is unlocked in Power Mode and the Android system of the Slate is locked, then the device information of the Base shall be added into the trusted device list during the switch, to enable the Slate to enter the automatic unlock state. This process allows the Base to unlock the screen of the Slate.

In another embodiment, the Slate can be inserted into the Base via a detachable connector. When the Slate is removed from the Base, if the Android system of the Slate is in the automatic unlock state, the information of the Base shall be removed from the trusted device list, which makes the Slate exit the automatic unlock state.

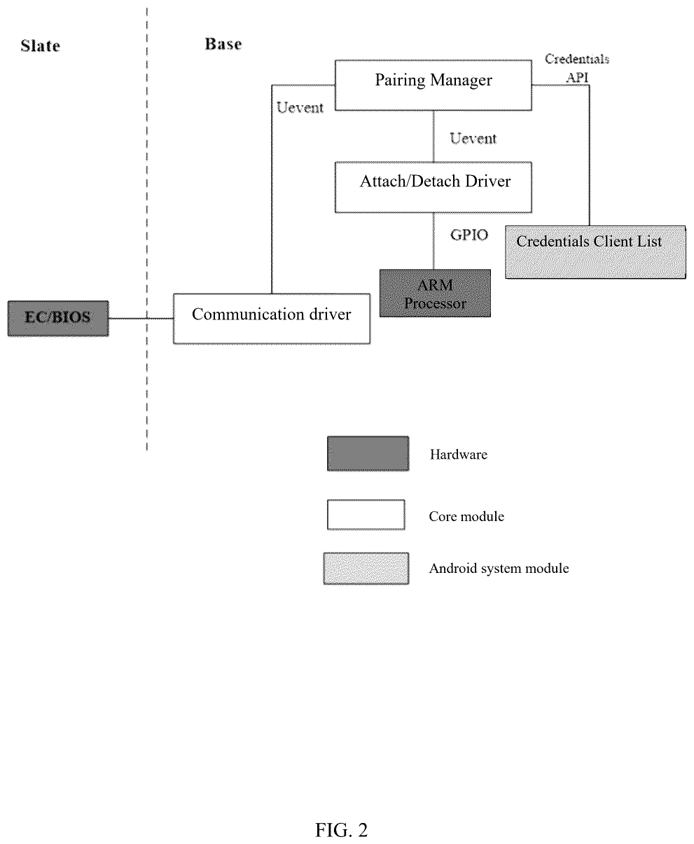

FIG. 2 is a diagram illustrating data processing information for the direct physical connection between the Slate and Base as provided in an embodiment of the present disclosure. Note that FIG. 2 only shows the diagram of some functional modules. More specifically, functional modules can be added or removed based on practical application requirements of the devices, which shall not be limited in this embodiment. On the Slate end, an Embedded Controller (EC) and a Basic Input Output System (BIOS) are presented. On the Base end, a pairing manager module, an attach/detach driver module, an ARM processor, a communication driver module, and a credentials client list module are presented. The main data processing flow includes:

Inserting the Slate into Base via a detachable connector.

The attach/detach detection module driver on the Slate end detects changes in the GPIO (General Purpose Input/Output Port). When an attach event is detected, it is reported to the pairing manager module. The pairing manager module on the Slate side receives the attach event and sends information to the communication driver module on the Slate to query the Bluetooth device information of the Base. The Bluetooth device information includes at least the Bluetooth name, Bluetooth MAC address, UUID (Universally Unique Identifier), pairing status and so on. The communication driver module on the Slate side requests the Bluetooth device information from the Base via the communication channel between the Slate and Base. Once retrieved, the information is sent to the pairing manager module on the Slate. The pairing manager module on the Slate verifies whether the Bluetooth device information corresponds to the paired Base/Slate Bluetooth device. If yes, then the Bluetooth device information of the Base is saved as the current Base-end Bluetooth device. The pairing manager module on the Slate invokes the access interface of the trusted device list (represented as Credentials API), to dynamically add the current Bluetooth device to the trusted device list (Credentials Client List), and then notifies the Android system of the updated authenticated device list. The Android system on the Slate then enters the automatic unlock mode.

Detaching the Slate from the Base by unplugging the detachable connector, wherein the direct physical connection of the two devices is disconnected.

The connection/disconnection driver on the Slate detects the detach event between the Slate and the Base through changes in the GPIO (General Purpose Input/Output Port), and then reports it to the pairing manager module. After receiving the detach event, the pairing manager module on the Slate invokes the access interface of the trusted device list (represented as the credentials API) to dynamically remove the saved Base Bluetooth device (current Base Bluetooth device) from the trusted device list (i.e. Credentials Client List), and then notifies the Android system of the updated authenticated device list. The Android system on the Slate then exits the automatic unlock mode.

The pairing process between the Slate and the Base is illustrated in detail as follows.

The Base (with X86/Windows operating system) initiates the pairing action (e.g., through a Windows App or a Windows service monitoring the pairing action). The Base sends its Bluetooth trusted device information to the Slate via the connection channel between the Base and the Slate. After receiving the Bluetooth trusted device information from the Base, the communication driver module on the Slate forwards it to the pairing manager module on the Slate. The pairing manager module then saves the Bluetooth-related information of Base into the trusted device list.

In the aforementioned embodiment, when the Slate and the Base are mechanically connected, the Bluetooth device information of the Base is added to the trusted device list. When the two devices are detached, the Bluetooth device information of the Base is then removed from the trusted device list. These operations ensure that the Slate exits the automatic unlock mode in the disconnected state, which guarantees its security.

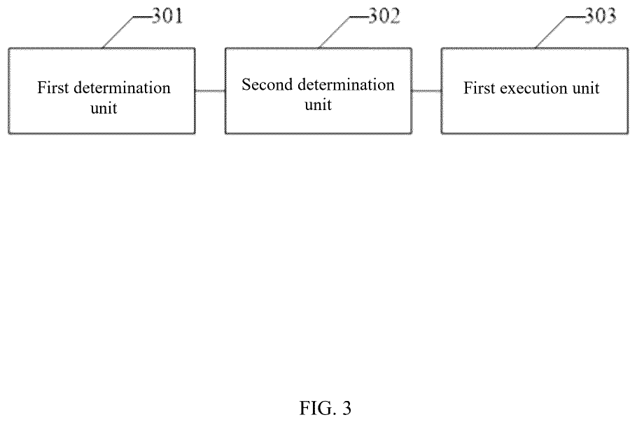

FIG. 3 is another embodiment of the apparatus for controlling devices provided in the present disclosure. This device is comprising:

A first determination unit 301, configured to determine that the state of a connection between the first device and the second device has changed;

A second determination unit 302, configured to determine that the first device is in the target state, wherein in the target state, the first device connects to the second device through the first connection, and based on the first connection, the first device maintains an unlocked screen state; and

A first execution unit 303, configured to execute a first operation, wherein the

first operation is used to transition the first device out of the target state.

In some embodiments of the present disclosure, the change in the state of a connection between the first device and the second device includes:

The first device and the second device switch from a first state of a connection to a second state of a connection, wherein in the first state of a connection, the first device receives and displays the display data of the second device, while the second device is in a locked screen state, and in the second state of a connection, the first device receives keyboard input data from the second device, and the first device displays its own display data.

In some embodiments of the present disclosure, the device further includes:

A third determination unit, configured to determine that the first device and the second device have switched from a third state of a connection to the second state of a connection, wherein in the third state of a connection, the first device receives and displays the display data of the second device, while the second device is in an unlocked screen state;

A fourth determination unit, configured to determine that the first device is not in the target state;

A second execution unit, configured to execute a second operation, wherein the second operation is used to make the first device enter the target state.

In some embodiments of the present disclosure, the change of the state of a connection between the first device and the second device includes:

The first device and the second device switch from a fourth state of a connection to a fifth state of a connection, wherein in the fourth state of a connection, the first device and the second device are connected through the first connection and the second connection, and in the fifth state of a connection, the first device and the second device is connected only through the first connection, while the second connection is disconnected.

Furthermore, the first connection is a wireless connection, and the second connection is a direct physical connection.

In some embodiments of the present disclosure, the first connection is a wireless connection, the second connection is also a wireless connection. The first connection is different from the second connection, and the maximum connection distance of the second connection is shorter than that of the first connection.

In some embodiments of the present disclosure, the first execution unit includes:

A first processing subunit, configured to remove the device information of the second device from the trusted device list of the first device, wherein if the first device establishes a specific connection with a device recorded in the trusted device list, the first device remains in an unlocked screen state.

In some embodiments of the present disclosure, the first execution unit includes:

a second processing subunit, configured to disconnect the first connection.

Note that the specific implementation of each unit and subunit in this embodiment can refer to the corresponding description earlier, and will not be detailed further here.

Another embodiment of the present disclosure provides a computer readable storage medium. A computer program is stored on the storage medium. The computer program implements the method for controlling devices as described in any of the preceding claims, when executed by a processor.

Another embodiment of the present disclosure also provides an electronic device. The electronic device includes:

A memory, used to store applications and the data generated during the execution of those applications;

A processor, used to execute the application to implement the method for controlling devices as described in any of the aforementioned embodiments.

The specific implementations of the processor in this embodiment can refer to the corresponding descriptions earlier, and will not be detailed further here.

In the above descriptions of the present disclosure, each embodiment is described in a progressive manner, with each embodiment focusing on its differences from the others. The similar or identical parts of the various embodiments can be referred to interchangeably. For the device disclosed in the embodiments, as it corresponds to the method disclosed in the embodiments, the description is relatively concise, and the relevant details can be found in the method description section.

Skilled professionals may further realize that the units and algorithm steps of the examples described in conjunction with the embodiments disclosed herein can be implemented using electronic hardware, computer software, or a combination of both. To clearly illustrate the interchangeability of hardware and software, the components and steps of each example have been described generally according to their functions in the above explanation. Whether these functions are executed in hardware or software depends on the specific application of the technical solution and the design constraints. Skilled professionals can use different methods to implement the described functions for each specific application, but such implementations should not be considered beyond the scope of this application.

The steps of the methods or algorithms described in conjunction with the embodiments disclosed herein can be implemented directly in hardware, in software modules executed by a processor, or in a combination of both. Software modules can be stored in random access memory (RAM), memory, read-only memory (ROM), electrically programmable ROM (EPROM), electrically erasable programmable ROM (EEPROM), registers, hard disks, removable disks, CD-ROMs, or any other form of storage medium known in the art.

The above descriptions of the embodiments enable those skilled in the art to implement or use the present disclosure. Various modifications to these embodiments will be apparent to those skilled in the art, and the general principles defined herein may be applied to other embodiments without departing from the spirit or scope of the present disclosure. Therefore, the present disclosure shall not be limited to the embodiments presented herein, but shall be accorded the broadest scope consistent with the principles and novel features disclosed herein.

What is claimed is:

1. A method for controlling devices, comprising:
determining that a state of a connection between a first device and a second device has changed;
determining that the first device is in a target state, wherein in the target state, the first device is connected to the second device through a first connection, and based on the first connection, the first device maintains an unlocked screen state; and
performing a first operation, the first operation being used to make the first device exit the target state.

2. The method according to claim 1, wherein the state of the connection between the first device and the second device has changed includes:
the connection between the first device and the second device having changed from a first state of the connection to a second state of the connection, wherein in the first state of the connection, the first device receives and displays display data from the second device, while the second device is in a locked screen state; and in the second state of the connection, the first device receives keyboard input data from the second device and displays its own display data.

3. The method according to claim 2, further comprising:
determining that the first device and the second device have switched from a third state of the connection to the second state of the connection, wherein in the third state of the connection, the first device receives and displays display data from the second device, while the second device is in the unlocked screen state; and
performing a second operation, wherein the second operation is used to make the first device enter the target state.

4. The method according to claim 1, wherein the state of the connection between the first device and the second device has changed includes:
the connection between the first device and the second device having changed from a fourth state of the connection to a fifth state of the connection, wherein in the fourth state of the connection, the first device and the second device are connected through both the first connection and a second connection, and in the fifth state of the connection, the first connection is maintained, and the second connection is disconnected.

5. The method according to claim 4, wherein the first connection is a wireless connection and the second connection is a direct physical connection.

6. The method according to claim 4, wherein the first connection is a wireless connection, and the second connection is a wireless connection, the first connection and the second connection being different, the maximum connection range of the second connection being shorter than that of the first connection.

7. The method according to claim 1, wherein performing the first operation includes:
removing the device information of the second device from a trusted device list of the first device, wherein the first device maintains the unlocked screen state if it establishes a connection with a device on the trusted device list.

8. The method according to claim 1, wherein the process of performing the first operation includes:
disconnecting the first connection.

9. A device control apparatus, comprising:
a first determination unit, configured to determine that a state of a connection between a first device and a second device has changed;
a second determination unit, configured to determine that the first device is in a target state, wherein in the target state, the first device is connected to the second device through a first connection, and based on the first connection, the first device maintains an unlocked screen state; and
a first execution unit configured to performing a first operation, the first operation being used to make the first device exit the target state.

10. A computer readable storage medium storing a computer program, wherein the computer program is executed by a processor to implement the method for controlling devices, comprising:
determining that a state of a connection between a first device and a second device has changed;
determining that the first device is in a target state, wherein in the target state, the first device is connected to the second device through a first connection, and based on the first connection, the first device maintains an unlocked screen state; and
performing a first operation, wherein the first operation is used to make the first device exit the target state.

11. The computer readable storage medium according to claim 10, wherein the state of the connection between the first device and the second device has changed includes:
the connection between the first device and the second device having changed from a first state of the connection to a second state of a connection, wherein in the first state of a connection, the first device receives and displays display data from the second device, while the second device is in a locked screen state; and in the second state of a connection, the first device receives keyboard input data from the second device and displays its own display data.

12. The computer readable storage medium according to claim 11, wherein the method further comprising:
determining that the first device and the second device have switched from a third state of the connection to the second state of the connection, wherein in the third state of the connection, the first device receives and displays display data from the second device, while the second device is in the unlocked screen state; and
performing a second operation, wherein the second operation is used to make the first device enter the target state.

13. The computer readable computer readable storage medium according to claim 10, wherein the state of the connection between the first device and the second device has changed includes:
the connection between the first device and the second device having changed from a fourth state of the connection to a fifth state of the connection, wherein in the fourth state of the connection, the first device and the second device are connected through both the first connection and a second connection, and in the fifth state of the connection, the first connection is maintained, and the second connection is disconnected.

14. The computer readable storage medium according to claim 13, wherein the first connection is a wireless connection and the second connection is a direct physical connection.

15. The computer readable storage medium according to claim 13, wherein the first connection is a wireless connection, and the second connection is a wireless connection; the first connection and the second connection are different; and the maximum connection range of the second connection is shorter than that of the first connection.

16. The computer readable storage medium according to claim 10, wherein the process of performing the first operation includes:
removing the device information of the second device from a trusted device list of the first device, wherein the first device maintains the unlocked screen state if it establishes a connection with a device on the trusted device list.

17. The computer readable storage medium according to claim 10, wherein the process of performing the first operation includes:
disconnecting the first connection.
